(19) United States
(12) Patent Application Publication
(10) Pub. No.: US 2002/0053233 A1
(43) Pub. Date: May 9, 2002

(54) Gas measurement probe

(75) Inventors: Harald Grieser, Renningen (DE); Andreas Andorfer, Hemmingen (DE); Gerhard Mattes, Sachsenheim-Hohenhaslach (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 09/989,141

(22) Filed: Nov. 21, 2001

(30) Foreign Application Priority Data
Nov. 23, 2000 (DE) 1 00 58 013.0

(51) Int. Cl. G01N 9/00; G01N 7/00

(52) U.S. Cl. 73/31.05; 73/23.31

(57) ABSTRACT

The invention relates to a gas measurement probe for determining at least one physical variable of a gas to be measured, in particular for determining the concentration of a gas component in an exhaust gas of an internal combustion engine, or for determining the temperature of the exhaust gas. The gas measurement probe as a housing with a thread, with which the gas measurement probe can be screwed into a counterpart thread of a measurement opening. On the housing, a region is provided, against which a tool can be positioned for screwing the gas measurement probe into the counterpart thread of the measurement opening. At least one annular groove is made in the region of the housing.

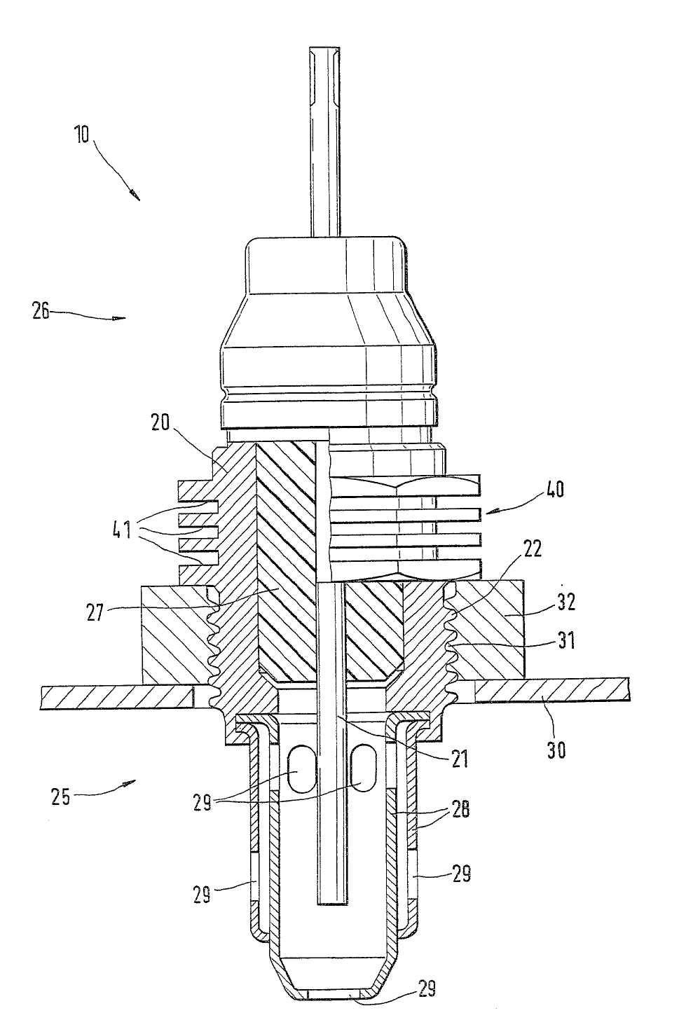

### BACKGROUND OF THE INVENTION

1. Field of the Invention

The invention is directed to a gas measurement probe particularly useful in determining the concentration of a gas component in a gas mixture or the temperature of the gas.

2. Description of the Prior Art

One gas measurement probe of the type with which this invention is concerned is known for instance from German Patent Disclosure DE 197 14 203 A1. Such gas measurement probes have a metal housing, with one end on the measurement side and one end on the connection side. The end on the measurement side of the gas measurement probe is placed in the measurement gas chamber, such as the exhaust pipe of an internal combustion engine. To that end, between its ends on the measurement side and the connection side, the gas measurement probe has a hexagonal body and a thread, so that with the aid of a tool engaging the hexagonal body, the gas measurement probe can be screwed into a counterpart thread of a measurement gas opening made in the exhaust pipe. The gas measurement probe secured in the measurement gas opening can be seated with its hexagonal body directly on the measurement gas opening.

From German Patent Disclosure DE 43 18 107, a gas measurement probe is also known, which with the aid of a union nut or a hollow screw can be secured in a measurement gas opening of an exhaust pipe. The union nut or hollow screw presses against a collar, acting as an abutment, that is made on the housing.

In operation, the exhaust gas and the exhaust pipe can have temperatures of over 1000° C. This heats the hexagonal body to temperatures of over 600° C. At such temperatures, in the region of the hexagonal body in the interior of the gas measurement probe, outgassing can occur, which impairs the intended function of the gas measurement probe.

### OBJECT AND SUMMARY OF THE INVENTION

The gas measurement probe of the invention has the advantage over the prior art that at least one annular groove is made in the region of the housing against which a tool can be positioned for screwing the gas measurement probe into the counterpart thread of the measurement gas opening. Because of the increase in surface area of this region, the heat transfer to the air surrounding the gas measurement probe is improved. This region is thus heated less severely in operation, even at high exhaust gas temperatures, thus markedly reducing the risk of outgassing. Furthermore, because of the improved heat transfer, the temperature on the connection end of the housing is lowered.

Another advantage is that because at least one annular groove is made, the region against which a tool can be positioned has a smaller mass. As a result, for instance in baking-out processes in production, the gas measurement probe can be heated faster to the required temperature, thus reducing the expenditure of both energy and time for this process step.

The gas measurement probe of one embodiment of the invention has the advantage over the prior art that because of the increased surface area of the securing means brought about by making at least one annular groove, an improved heat transfer to the ambient air is possible. Thus the securing means and hence also the housing are heated less severely during operation.

### BRIEF DESCRIPTION OF THE DRAWING

The invention will be better understood and further objects and advantages thereof will become more apparent from the ensuing detailed description of preferred embodiments taken in conjunction with the sole drawing FIGURE which shows a view, partly in section, of one exemplary embodiment of a gas measurement probe of the invention.

### DESCRIPTION OF THE PREFERRED EMBODIMENTS

The drawing shows a gas measurement probe 10, as an exemplary embodiment of the invention, with a housing 20 in which a sensor element 21 is disposed. The housing 20 has one portion 25 on the measurement side and one portion 26 on the connection side. The sensor element 21 is fixed in the housing 20 by a packing 27, which at the same time serves to seal off the portion 25 on the measurement side of the housing 20 from the portion 26 on the connection side of the housing 20. A double-walled protective tube 28 is fixed to the portion 25 on the measurement side of the housing 20 and has openings 29, which permit the gas to be measured to enter through to the sensor element 21.

With its portion 25 on the measurement side of the housing 20 and with the protective tube 28, the gas measurement probe 10 protrudes into an exhaust pipe 30 of an internal combustion engine. For securing the gas measurement probe 10 to the exhaust pipe 30, a thread 22 is provided on the housing 20; with this thread, the gas measurement probe 10 can be screwed into a counterpart thread 31 of a measurement opening element 32 of the exhaust pipe 30. To exert the requisite torque for screwing the gas measurement probe in, a hexagonal body 40, which can for instance be engaged by a hexagonal-socket wrench, is provided on the housing 20, adjacent to the thread 22.

Three annular grooves 41 are made in the hexagonal body 40, in a plane perpendicular to the longitudinal axis of the housing 20. The annular grooves and the housing are coaxial. The inside diameter of the housing 20 in the region of the hexagonal body 40 is about 9 mm, while the (minimal) outer diameter of the hexagonal body 40 is about 21 mm. The depth of the annular grooves 41 is about 3 mm, and the spacing of the annular grooves 41 from the inside surface of the housing 20 is likewise about 3 mm. Thus the stability of the housing 20 is not impaired by the annular grooves 41.

The width of the annular grooves 41 is about 1 mm. In the choice of the width and hence also of the number of annular grooves, it must be taken into account that for a higher number of annular grooves, while the surface area grows, nevertheless because of the lesser width resulting from a higher number, the air circulation is worse. In this exemplary embodiment, the best heat transfer proves to be attainable when three annular grooves 41 are provided. Compared to a gas measurement probe without annular grooves, a reduction in the temperature of the hexagonal body was obtained of 35° C., down to about 550° C. In the choice of the width of the annular grooves, it should also be considered that the width of the annular grooves should amount at most to half the width of the tool positioned against the hexagonal body.

In a further exemplary embodiment of the invention, not shown, the housing of the gas measurement probe has an annular collar and a securing means, such as a union nut or a hollow screw. For securing the gas measurement probe, the securing means is thrust over the gas measurement probe and screwed into the measurement opening of the exhaust pipe. The collar of the gas measurement probe acts as an abutment for the securing means in this process. Annular grooves are made in the securing means on the outside, and as a result the heat transfer to the ambient air is improved. The dimensions of the annular grooves in the securing means are arrived at by the same criteria as in the exemplary embodiment described above.

By way of example, the annular grooves can be made in the hexagonal body 40 or in the securing means by turning on a lathe.

The foregoing relates to preferred exemplary embodiments of the invention, it being understood that other variants and embodiments thereof are possible within the spirit and scope of the invention, the latter being defined by the appended claims.

We claim:

1. A gas measurement probe for determining at least one physical variable of a gas to be measured, in particular for determining the concentration of a gas component in an exhaust gas of an internal combustion engine, or for determining the temperature of the exhaust gas, the probe comprising a housing having a thread with which the gas measurement probe can be screwed into a counterpart thread of a measurement opening and having a region against which a tool can be positioned for screwing the gas measurement probe into the counterpart thread of the measurement opening, and at least one annular groove (41) formed in the region (40) of the housing (20).

2. The gas measurement probe according to claim 1, wherein said at least one annular groove (41) is disposed in a plane perpendicular to the longitudinal axis of the housing (20).

3. The gas measurement probe according to claim 1, wherein said at least one annular groove (41) and the housing (20) are coaxial.

4. The gas measurement probe according to claim 2, wherein said at least one annular groove (41) and the housing (20) are coaxial.

5. The gas measurement probe according to claim 1, wherein the region (40) of the housing (20) is a hexagonal body.

6. The gas measurement probe according to claim 2, wherein the region (40) of the housing (20) is a hexagonal body.

7. The gas measurement probe according to claim 3, wherein the region (40) of the housing (20) is a hexagonal body.

8. The gas measurement probe according to claim 4, wherein the region (40) of the housing (20) is a hexagonal body.

9. A gas measurement probe for determining at least one physical variable of a gas to be measured, in particular for determining the concentration of a gas component in an exhaust gas of an internal combustion engine, or for determining the temperature of the exhaust gas, said probe comprising a housing having an annular collar, securing means provided with a thread and engaging said collar, said securing means being adapted to be screwed into a counterpart thread of a measurement opening, and at least one annular groove in the securing means.

10. The gas measurement probe according to claim 9, wherein said securing means is a hollow screw and/or a union nut.

11. The gas measurement probe according to claim 9, wherein said securing means has a hexagonal head.
